(19) United States
(12) Patent Application Publication
(10) Pub. No.: US 2024/0040656 A1
(43) Pub. Date: Feb. 1, 2024

(54) TRANSMISSION CONFIGURATION INDICATOR INDICATION AND APPLICATION

(71) Applicant: ZTE Corporation, Shenzhen (CN)

(72) Inventors: Shijia SHAO, Shenzhen (CN); Bo GAO, Shenzhen (CN); Shujuan ZHANG, Shenzhen (CN); Ke YAO, Shenzhen (CN); Yang ZHANG, Shenzhen (CN); Zhaohua LU, Shenzhen (CN)

(21) Appl. No.: 18/483,160

(22) Filed: Oct. 9, 2023

Related U.S. Application Data
(63) Continuation of application No. PCT/CN2022/090042, filed on Apr. 28, 2022.

(51) Int. Cl. H04W 76/20; H04W 72/232

(52) U.S. Cl. CPC H04W 76/20; H04W 72/232

(57) ABSTRACT

A method of wireless communication includes receiving, by a wireless communication device, from a network device, a first parameter indicated by a first signaling message; wherein the first signaling message configuring a plurality of transmission configuration states; determining, by the wireless device, a mapping relationship between the plurality of transmission configuration states and a plurality of group information sets according to the first parameter; receiving, by the wireless device, from a network device, an indication of the plurality of transmission configuration states according to a second signaling message; and applying, by the wireless device, the plurality of transmission configuration states to a transmission; wherein the plurality of transmission configuration states include transmission configuration indicator (TCI) states.

### CROSS-REFERENCE TO RELATED APPLICATION

This application is a continuation and claims priority to International Application No. PCT/CN2022/090042, filed on Apr. 28, 2022, the disclosure of which is hereby incorporated by reference herein in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to reporting or using channel state information.

In one example aspect, a wireless communication method is disclosed. The method includes receiving, by a wireless communication device, from a network device, a first parameter indicated by a first signaling message; wherein the first signaling message configuring a plurality of transmission configuration states; determining, by the wireless device, a mapping relationship between the plurality of transmission configuration states and a plurality of group information sets according to the first parameter; receiving, by the wireless device, from a network device, an indication of the plurality of transmission configuration states according to a second signaling message; and applying, by the wireless device, the plurality of transmission configuration states to a transmission; wherein the plurality of transmission configuration states include transmission configuration indicator (TCI) states.

In another example aspect, another wireless communication method is disclosed. The method includes receiving, by a wireless communication device, from a network device, a transmission configuration indicator (TCI) state by a signaling message; determining, by the wireless communication device, TCI state for repetitive transmissions based on the occurrence of beam application time (BAT).

In one example aspect, a wireless communication method is disclosed. The method includes transmitting, by a network device, to a wireless communication device, a first parameter indicated by a first signaling message; wherein the first signaling message configuring a plurality of transmission configuration states; determining, by the wireless device, a mapping relationship between the plurality of transmission configuration states and a plurality of group information sets according to the first parameter; transmitting, by the network device, to the wireless device, an indication of the plurality of transmission configuration states according to a second signaling message; and applying, by the wireless device, the plurality of transmission configuration states to a transmission; wherein the plurality of transmission configuration states include transmission configuration indicator (TCI) states.

In one example aspect, a wireless communication method is disclosed. The method includes transmitting, by a network device, to a wireless communication device, a transmission configuration indicator (TCI) state by a signaling message; determining, by the wireless communication device, TCI state for repetitive transmissions based on the occurrence of beam application time (BAT).

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 is a block diagram example of a wireless communication system.

FIG. 3 shows an example of a relationship between MAC-CE and group information set.

FIG. 4 shows an example of codepoint activation by MAC-CE.

FIG. 5 shows another example of codepoint activation by MAC-CE.

FIG. 6 shows an example of beam application time.

FIG. 7 shows an example of beam application time during sequential transmission process.

FIG. 8 shows another example of beam application time during sequential transmission process.

FIG. 9 shows another example of beam application time during sequential transmission process.

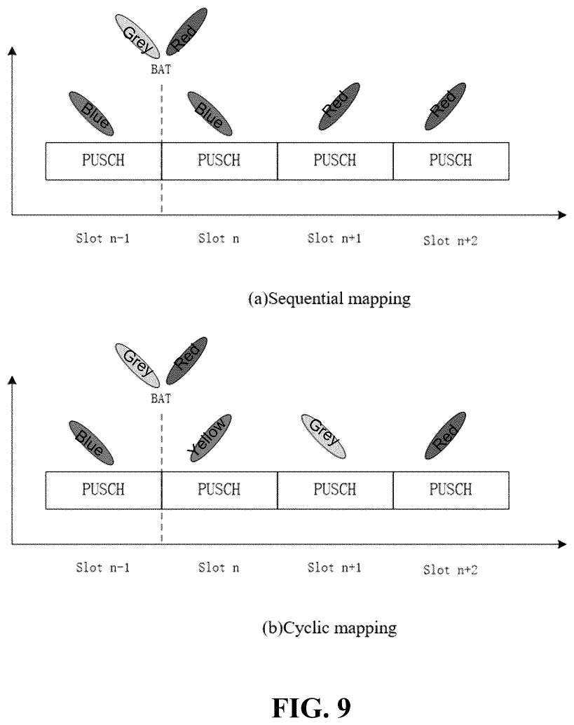

FIG. 10 is a flowchart illustrating an example method.

FIG. 11 is a flowchart illustrating an example method.

FIG. 12 is a flowchart illustrating an example method.

FIG. 13 is a flowchart illustrating an example method.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

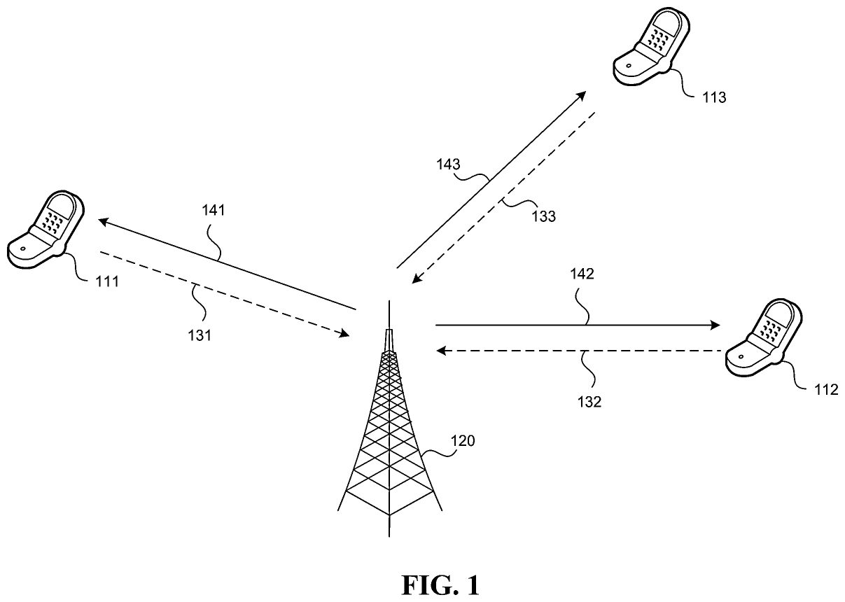

FIG. 1 shows an example of a wireless communication system (e.g., a long-term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

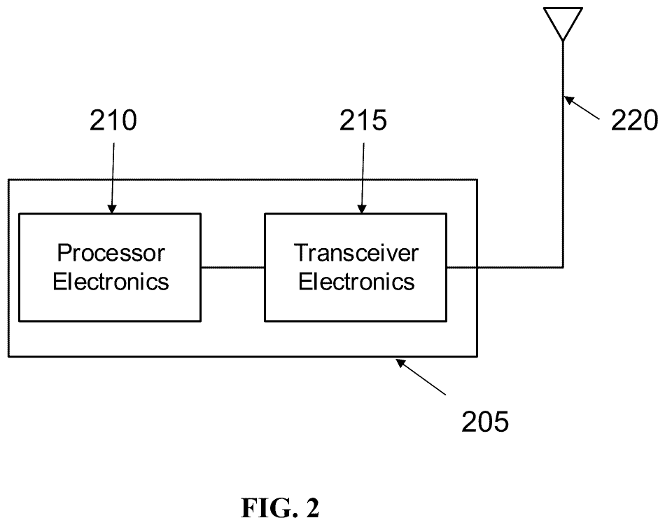

FIG. 2 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

To improve coverage at the cell edge and reduce the negative impact of the blocking effect, the Multi TRP (Transmission and Reception Point) (MTRP) technology has become an important technical method in the 5G New Radio (NR) system. With gradually standardized MTRP technology and with the evolution of R16/17, the MTRP technology has improved steadily. Additionally, unified transmission configuration indicator (TCI) framework is used for unifying the uplink and downlink beam indication modes. However, the R17 unified TCI framework is mainly designed for the single TRP (STRP) scenario and its useability or compatibility with the MTRP scenario would require further improvement.

This document is intended to solve potential issues and improve the unified TCI framework for MTRP scenario. This document provides three resolutions and improvements. First, to enhance the association between TCI states and TRPs according to MAC-CE indication. Second, to enhance the DCI indication for MTRP unified TCI states. Third, to enhance the beam application time for MTRP.

A Multi-TRP (Multiple Transmission and Reception Point) approach uses multiple TRPs to effectively improve the transmission throughput in the Long-Term Evolution (LTE), Long Term Evolution-Advanced (LTE-A) and New Radio access technology (NR) in the Enhanced Mobile Broadband (eMBB) scenario. At the same time, the use of Multi-TRP transmission or reception can effectively reduce the probability of information blockage and improve the transmission reliability in URLLC (Ultra-reliability and Low Latency Communication) scenarios.

According to the mapping relationship between transmitted signal flow and multi- TRP/panel, the Coordinated Multiple Points Transmission/Reception can be divided into two types: Coherent transmission and non-coherent transmission. For coherent transmission, each data layer is mapped to multiple-TRPs/Panels through weighted vectors. However, in the actual deployment environment, this mode has higher requirements for synchronization between TRPs and the transmission capability of backhaul links, and is sensitive to many non-ideal factors.

By comparison, Non-coherent Joint Transmission (NCJT) is less affected by the above factors. NCJT used to be a major consideration in R15 Coordinated Multiple Points Transmission/Reception. NCJT means that each data flow is only mapped to the port corresponding to the TRP/Panel with the same channel large-scale parameters (QCL). Different data flows can be mapped to different ports with different large-scale parameters, and all TRPs do not need to be processed as a virtual array.

Unified TCI framework was introduced in Rel-17 to unify uplink and downlink TCI state indication mode. That is, the spatial relation and power control parameters for uplink transmission are replaced by TCI states. However, the current framework is only applicable to the STRP scenario. Therefore, further studies of enhancement for MTRP unified TCI framework are needed.

Note that, in this document, the definition of “beam” is equivalent to quasi-co-location (QCL) state, transmission configuration indicator (TCI) state, spatial relation state (also called as spatial relation information state), reference signal (RS), spatial filter or pre-coding. Specifically,

A) The definition of “Tx beam” is equivalent to QCL state, TCI state, spatial relation state, DL/UL reference signal (such as channel state information reference signal (CSI-RS), synchronization signal block (SSB) (also known as SS/PBCH), demodulation reference signal

(DMRS), sounding reference signal (SRS), and physical random-access channel (PRACH)), Tx spatial filter or Tx precoding.

B) The definition of “Rx beam” is equivalent to QCL state, TCI state, spatial relation state, spatial filter, Rx spatial filter or Rx precoding.

C) The definition of “beam ID” is equivalent to QCL state index, TCI state index, spatial relation state index, reference signal index, spatial filter index or precoding index.

Specifically, the spatial filter can be either UE-side or gNB-side one, and the spatial filter is also called as spatial-domain filter.

Note that “spatial relation information” is comprised of one or more of the reference RSs, where it is used to represent “spatial relation” between targeted “RS or channel,” and one or more reference RSs, where “spatial relation” means the same/quasi-co beam(s), same/quasi-co spatial parameter(s), and same/quasi-co spatial domain filter (s).

Note that “spatial relation” means the beam, spatial parameter, and spatial domain filter.

Note that “QCL state” is comprised of one or more of the reference RSs and the corresponding QCL type parameters, where QCL type parameters include at least one of the following aspect or combination: [1] Doppler spread, [2] Doppler shift, [3] delay spread, [4] average delay, [5] average gain, and [6] Spatial parameter (also known as spatial Rx parameter).

In this document, “TCI state” is equivalent to “QCL state”. The definitions for ‘QCL-TypeA’, ‘QCL-TypeB’, ‘QCL-TypeC’, and ‘QCL-TypeD’ are:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Note that “UL signal” can be PRACH, PUCCH, PUSCH, UL DMRS, and SRS.

Note that “DL signal” can be PDCCH, PDSCH, SSB, DL DMRS, and CSI-RS.

Note that group-based reporting comprises at least one of “beam group” based reporting and “antenna group” based reporting.

Note that the definition of “beam group” means different Tx beams within the same group may be simultaneously received or transmitted, and/or Tx beams between different groups may not be simultaneously received or transmitted. The definition of “beam group” is described from the UE's perspective.

Note that “BM RS” means beam management reference signal, and it can be CSI-RS, SSB or SRS.

Note that “group information” indicates “information of grouping one or more reference signals,” “transmission and reception point (TRP),” “resource set,” “panel,” “sub-array,” “antenna group,” “antenna port group,” “group of antenna ports,” “beam group,” “physical cell index (PCI),” “TRP index,” “CORESET pool ID,” or “UE capability set.”

Note that “BM RS group” is equivalent to “grouping one or more BM reference signals” and BM RSs from a group are associated with the same TRP.

Note that “TRP index” is equivalent to “TRP ID”, which is used to distinguish different TRPs.

Note that “panel ID” is equivalent to UE panel index.

### EMBODIMENT 1: ASSOCIATION BETWEEN TCI STATES AND TRP

In Rel-17, DL/UL common pool and separate pool have both been agreed to unified TCI framework. TCI states in common pool can be indicated for downlink transmission or uplink transmission or both downlink and uplink transmission. However, TCI states in DL separate pool are only indicated for downlink transmission and TCI states in UL separate pool are only indicated for uplink transmission.

To apply the R17 unified TCI framework to MTRP scenario, it is important to ensure that the UE knows that the configured TCI is designated for specific group information set (e.g., TRP), meaning that the UE acknowledges the association between TCI states and group information sets (e.g., TRPs).

The association between TCI states and group information sets (e.g., TRPs) can be indicated by Medium Access Control-Control Element (MAC-CE).

For MAC-CE indication, N MAC-CE is used to active TCI state codepoint(s) corresponding to N group information set (e.g., N TRPs). The association between TCI states and group information sets (e.g., TRPs) are indicated by a parameter in each MAC-CE.

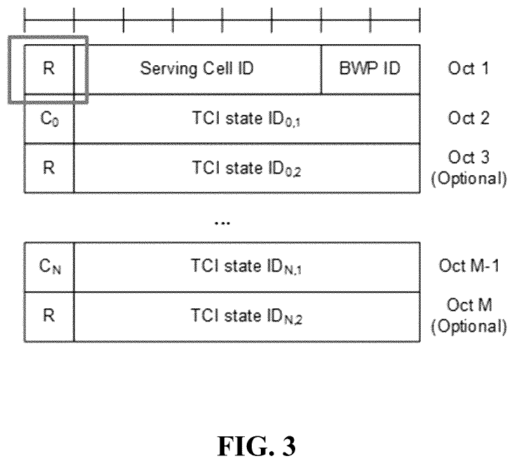

Each MAC-CE corresponds to one group information set (e.g., TRP), the R field, boxed element in FIG. 3, in the MAC-CE is used to indicate the relationship between MAC-CE and group information set (e.g., TRP).

For M-DCI, UE is either provided with two coresetPoollndex values, 0 and 1, for the first and second CORESETs respectively, or is only provided with coresetPoollndex value of 1 for the second CORESETs, but no coresetPoollndex value for the first CORESETs. Thus, coresetPoollndex is used as the parameter.

For S-DCI, UE is not provided any coresetPoollndex for the first and second CORESETs. New ID, such as TCI state pool ID/TRP-ID, is introduced as the parameter.

In some cases, implicit indexes can be used for the association can be used. example implicit indexed includes UE capability set index, physical cell index (PCI), CSI-RS resource set index, and SRS resource set index. Furthermore, the UE capability comprises a number of antenna ports (e.g., SRS antenna ports), a number of layers (e.g., for PUSCH, or PDSCH), and the UE panel ID/index.

As noted, the above indexes, TCI state pool ID/TRP-ID, the UE capability set index, CSI-RS resource set index, SRS resource set index, can also be used in the MDCI scenario.

Scheme-1: 1 codepoint is associated with 2 joint TCI states or 2 separate TCI state pairs, each activation is done from a separate MAC-CE (e.g., group information set should also be indicated in the separate MAC-CE).

One of the separate TCI state pair includes one or more downlink/uplink TCI states, such as one downlink TCI state and one uplink TCI state, or one downlink TCI state, or one uplink TCI state.

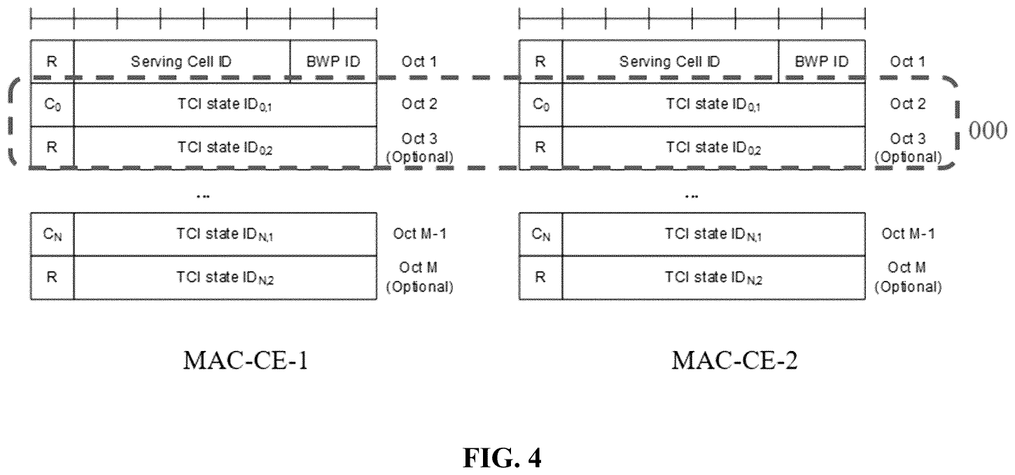

Step 1: MAC-CE activation. As shown in FIG. 4, a maximum of eight codepoints can be activated by two MAC-CEs. A default combination can be used for codepoint arrangement. For example, the Nth TCI state(s) activated by the first MAC-CE and the Nth TCI state(s) activated by the second MAC-CE to form the Nth codepoint. The corresponding relationship between each codepoint and TCI state is shown in Table 1. (Note some of the TCI states in MAC-CE can be set as ‘dummy’ states)

TABLE 1

| Codepoint | DCI TCI | | |
|---|---|---|---|
| index | field | MAC-CE-1 | MAC-CE-2 |
| 0 | 000 | TCI state ID_{0, 1} + | TCI state ID_{0, 1} + |
| | | TCI state ID_{0, 2} | TCI state ID_{0, 2} |
| 1 | 001 | TCI state ID_{1, 1} + | TCI state ID_{1, 1} + |
| | | TCI state ID_{1, 2} | TCI state ID_{1, 2} |

. . .

| | | | |
|---|---|---|---|
| 7 | 111 | TCI state ID_{7, 1} + | dummy |
| | | TCI state ID_{7, 2} | |

Step 2: DCI selection. For unified TCI framework, DCI “Transmission Configuration Indication” field indicates one TCI state codepoint based on active TCI states.

To handle the challenge that TCI state(s) in the codepoint may not be available for DL/UL simultaneous transmission or gNB wants to switch to single group information set scenario, addition DCI field is introduced and 2-bit is used for TCI state selection and TCI state transmission order indication, as shown in Table 2.

TABLE 2

| | |
|---|---|
| 00 | Only used TCI state associated with group information set 1 |
| | (e.g., TRP 1) |
| 01 | Only used TCI state associated with group information set 2 |
| | (e.g., TRP 2) |
| 10 | group information set 1 (e.g., TRP 1), |
| | group information set 2 (e.g., TRP 2) order |
| 11 | group information set 2 (e.g., TRP 2), |
| | group information set 1 (e.g., TRP 1) order |

Addition DCI field and RRC configuration are used when deciding whether to switch to another mode can be configured by RRC and 1-bit DCI field can be used for TCI state selection.

Table 3 shows when the dynamic switch mode is configured, 1-bit is only used for TCI state selection:

TABLE 3

| | |
|---|---|
| 0 | Only used TCI state associated with group information set 1 |
| | (e.g., TRP 1) |
| 1 | Only used TCI state associated with group information set 2 |
| | (e.g., TRP 2) |

Table 4 shows when the dynamic switch mode is not configured (Note: it is not necessary to include DCI TCI field), 1-bit is only used for TCI state transmission order indication.

TABLE 4

| | |
|---|---|
| 0 | group information set 1 (e.g., TRP 1), |
| | group information set 2 (e.g., TRP 2) order |
| 1 | group information set 2 (e.g., TRP 2), |
| | group information set 1 (e.g., TRP 1) order |

DCI selects one codepoint that contains one joint TCI states or one separate TCI state pair that is activated from one MAC-CE and one dummy value from another MAC-CE, as shown in Table 1, codepoint 7.

Scheme-2: 1 codepoint is associated with 1 single joint TCI or 1 TCI state pair state corresponding to 1 single group information set.

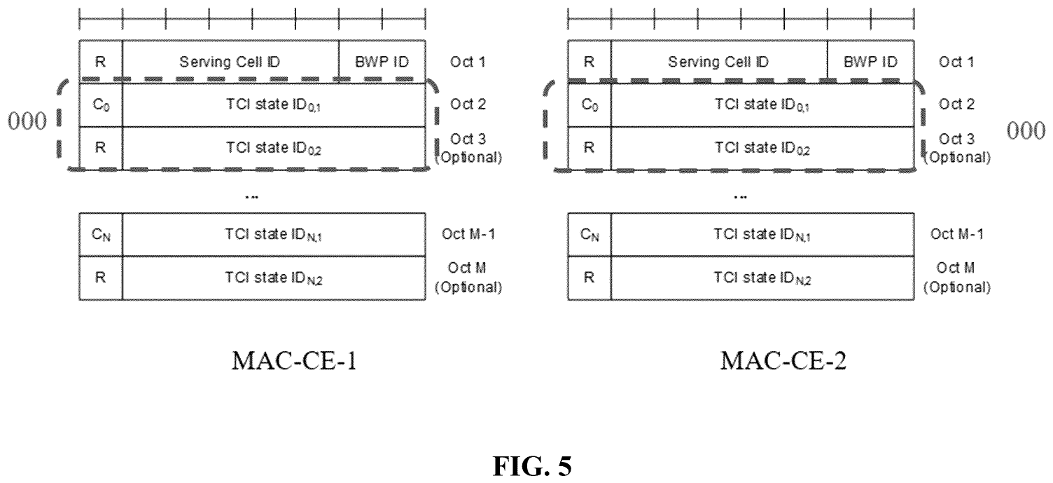

Step 1: MAC-CE activation. As shown in FIG. 5, a maximum of eight codepoints can be activated by each MAC-CEs.

Step 2: DCI selection. For unified TCI framework, DCI “Transmission Configuration Indication” field indicates one TCI state codepoint based on active TCI states.

Additional TCI field can be introduced to indicate codepoint activated by the second MAC-CE.

Such as the existing TCI field is used to indicate codepoint activated by the first MAC-CE. The first MAC-CE refers to the MAC-CE contains the lowest value of the association parameter. For example, the lowest index of TCI state pool ID/TRP-ID, UE capability set, CSI-RS resource set, SRS resource set or the value 0 of coresetPoolIndex.

To handle the challenge that TCI state(s) in the codepoint may not be available for DL/UL simultaneous transmission or gNB wants to switch to a single group information set scenario, only one TCI field can be used to indicate TCI states. Additional DCI field can be introduced, such as use 1-bit to indicate the existing TCI field corresponds to which MAC-CE or group information set, as shown as table 5.

TABLE 5

| | |
|---|---|
| 0 | Correspond to the first MAC-CE |
| | (associated with group information set 1) |
| 1 | Correspond to the second MAC-CE |
| | (associated with group information set 2) |

In addition to the schemes discussed above, implicit rules can be implemented. One of the implicit rules can be that the MAC-CE associated with group information setID corresponding to the scheduling DCI will be selected. Another implicit rules can be based on DCI transmission occasion, such as if DCI is transmitted on odd slot, the first MAC-CE will be selected or if DCI is transmitted on even slot, the first MAC-CE will be selected. Yet, another implicit rules can be that DCI does not have DL assignment, but the reserved field can be used for indication, such as ‘HARQ-ACK process number’ field. (4 bit).

Both TCI fields can be used to indicate TCI states for single group information set. Different fields used to indicate TCI state can be used for different channels.

For DL and UL channel, for example, the first field is used to indicate TCI state for DL channel (e.g. PDCCH/PDSCH) and the second field is used to indicate TCI state for UL channel (e.g. PUCCH/PUSCH).

For control and data channel, for example, the first field is used to indicate TCI state for control channel (e.g. PDCCH/PUCCH) and the second field is used to indicate TCI state for data channel (e.g. PDSCH/PUSCH).

Both TCI fields can be used to indicate TCI states for multiple group information sets handover. For example, the first field is used to indicate TCI state for current group information set for transmission and the second field is used to indicate TCI state for the group information set that may be handed over in the future. This helps the UE to prepare for group information set handover, notifying the group information set information of the to-be-handed handover in advance, thus reducing the delay required for handover.

### EMBODIMENT 2: BEAM APPLICATION TIME

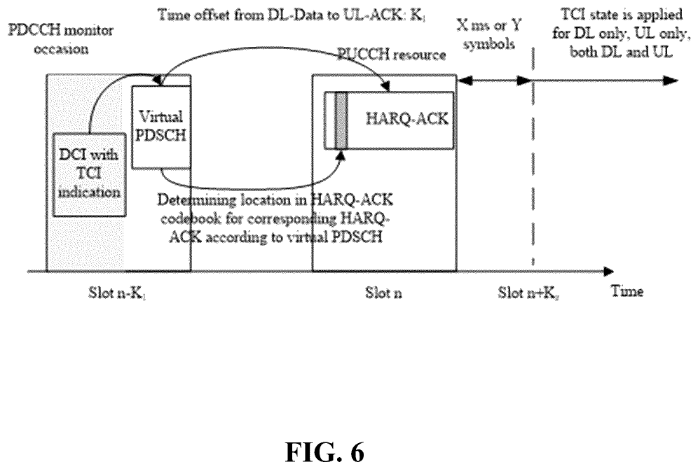

In unified TCI state indication, for DCI-based beam indication with respect to application time of the beam indication, Y symbols appear in the first slot after the last symbol of the acknowledgment of the joint or separate DL/UL beam indication. In which, the first slot and the Y symbols are both determined based on the carrier with the smallest SCS among carrier(s) that are applying the beam indication. Y is configured by RRC. To enhance application of the MTRP scenario, the beam application time needs to be further clarified, as shown in FIG. 6.

Separate beam application time (BAT) timeline(s) for each group information set is configured with one or more of the following information: Y is configured at per Bandwidth Part (BWP) for all group information set and Y is configured at per BWP for each TRP.

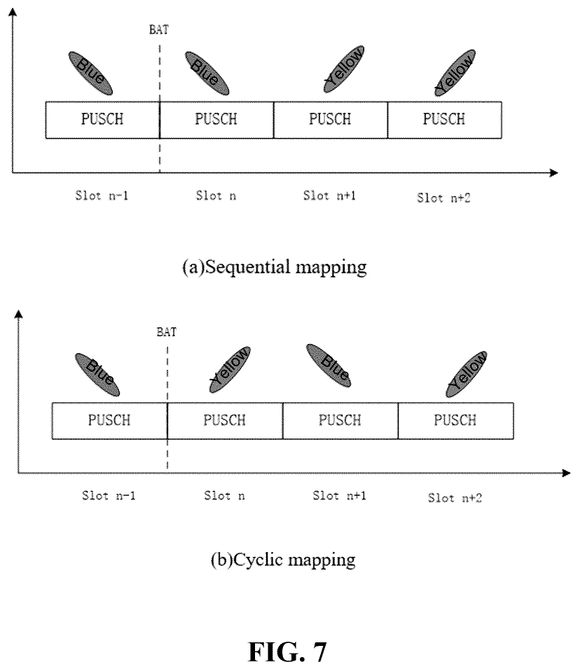

When BAT time occurs during the process of repetition transmission, consideration of the TCI state applicability is needed. The downlink channels (e.g., PDSCHs) that carry the same data block may be referred to as repetition occasions or repetitive transmissions. As shown in FIG. 7.

Option-1: the application of TCI state(s) for a repetition is determined according to the first slot in the sequential transmission pattern. If the BAT time occurs before the first slot of sequential transmission pattern, UE will apply the TCI state for this sequential transmission pattern. If the BAT time occurs after the first slot of sequential transmission pattern, UE will not apply the TCI state for this sequential transmission pattern.

The sequential transmission pattern is 2 continuous transmissions corresponding to the same group information set.

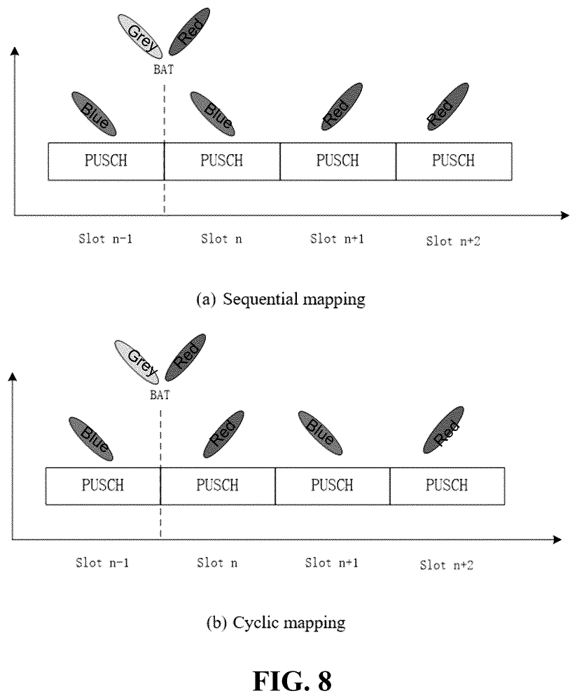

As shown in FIG. 8(a), the application time is applied to the time after the first slot of the first sequential transmission pattern with the first TCI state (blue beam), so the TCI state of the first sequential transmission pattern remains unchanged. The application time is applied to the time before the first slot of the second sequential transmission pattern with the second TCI state (yellow beam), so the updated second TCI state (red beam) transmission is applied for the second sequential transmission pattern.

Option-2: the application of TCI state(s) for a repetition is determined according to the first slot in the group information set transmission pattern. If the BAT time occurs before the first slot of group information set transmission pattern, UE will apply the TCI state for this group information set transmission pattern. If the BAT time occurs after the first slot of group information set transmission pattern, UE will not apply the TCI state for this group information set transmission pattern.

The group information set transmission pattern is all transmissions corresponding to the same group information set.

As shown in FIG. 8(b), the application time is applied to the time after the first slot of the first group information set transmission pattern with the first TCI state (blue beam), so the TCI state of the first group information set transmission pattern remains unchanged. The application time is applied to the time before the first slot of the second group information set transmission pattern with the second TCI state (yellow beam), so the updated second TCI state (red beam) transmission is applied for the second group information set transmission pattern.

Option-3: the application of TCI state(s) for a repetition is determined according to the first slot in the cyclic transmission pattern. If the BAT time occurs before the first slot of cyclic transmission pattern, UE will apply the TCI state for this cyclic transmission pattern. If the BAT time occurs after the first slot of cyclic transmission pattern, UE will not apply the TCI state for this cyclic transmission pattern.

The cyclic transmission pattern is two non-continuous transmissions correspondto different group information sets.

As shown in FIG. 8(b), the application time is applied to the time after the first slot of the first cyclic transmission pattern with the first TCI state (blue beam), so the TCI state of the first cyclic transmission pattern remains unchanged. The application time is applied to the time before the first slot of the second cyclic transmission pattern with the second TCI state (yellow beam), so the updated second TCI state (red beam) transmission is applied for the second cyclic transmission pattern.

Option-4: If the BAT time occurs after the first slot of the whole repetition transmission pattern, UE expects not to change TCI states for the whole repetition.

Option-5: whether to apply the new TCI state is up to UE capability.

Accordingly, some preferred embodiments may use the following solutions.

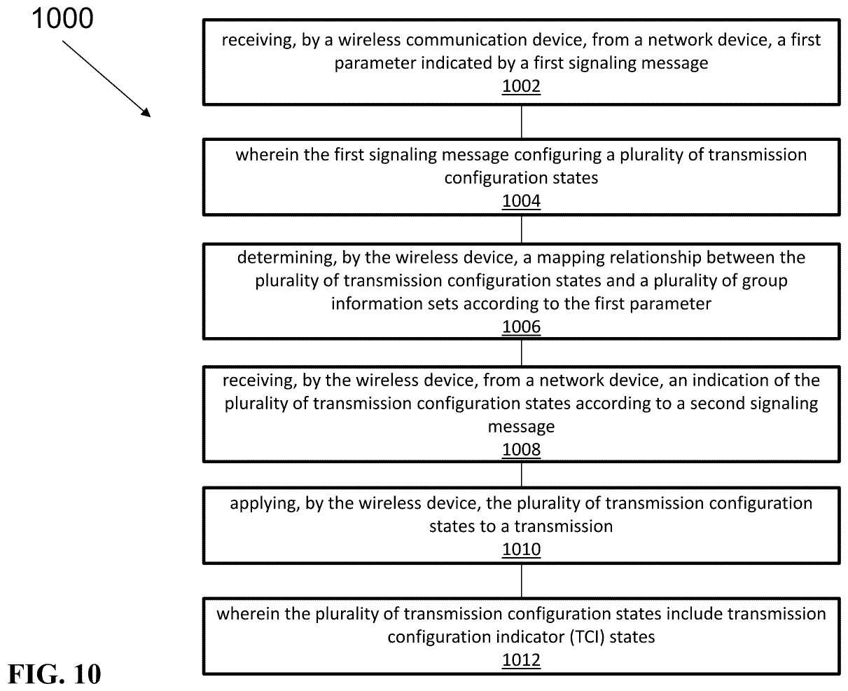

1. A method of wireless communication, as disclosed in FIG. 10: including receiving, by a wireless communication device, from a network device, a first parameter indicated by a first signaling message (1002); wherein the first signaling message configuring a plurality of transmission configuration states (1004); determining, by the wireless device, a mapping relationship between the plurality of transmission configuration states and a plurality of group information sets according to the first parameter (1006); receiving, by the wireless device, from a network device, an indication of the plurality of transmission configuration states according to a second signaling message (1008); and applying, by the wireless device, the plurality of transmission configuration states to a transmission (1010); wherein the plurality of transmission configuration states include transmission configuration indicator (TCI) states (1012).

2. The method of solution 1, wherein the first signaling message comprising a plurality of Medium Access Control-Control Element (MAC-CE) signalings.

3. The method of solution 1, wherein the first parameter further comprising a first index that indicates the mapping relationship between the plurality of transmission configuration states and the plurality of group information sets.

4. The method of solution 1, wherein the second signaling message comprising a downlink control information (DCI) signaling.

5. The method of solution 4, wherein a plurality of codepoints are indicated by the second signaling message.

6. The method of solution 5, wherein one codepoint comprises a first group of transmission configuration states and a second group of transmission configuration states; wherein the first group of transmission configuration and the second group of transmission configuration are activated by the first signaling message.

7. The method of solution 4, wherein the group of transmission configuration states comprise one or more of the following TCI states: a joint TCI state, and a separate TCI state pair.

8. The method of solution 4, wherein the second signaling message further comprising one or more of the following TCI information: TCI state selection information and TCI state transmission order information.

9. The method of solution 5, wherein one codepoint comprises a first group of transmission configuration states or a second group of transmission configuration states; wherein the first group of transmission configuration and the second group of transmission configuration are activated by the first signaling message.

10. The method of solution 4, wherein the second signaling message further comprising one or more of the following information: information for different transmission channels and information for different group information sets.

11. The method of solution 9, wherein the second signaling message further establish an association between the first signaling message and a field in the second signaling message.

12. The method of solution 11, the association between he first signaling message and the field in the second signaling message further indicated by default rules.

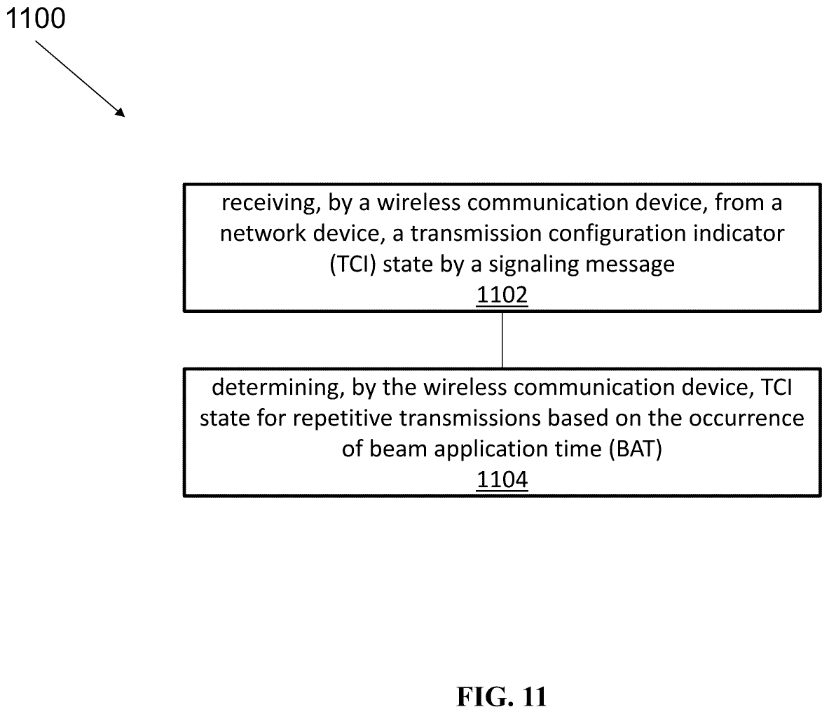

13. A method of wireless communication, as shown in FIG. 11, including receiving, by a wireless communication device, from a network device, a transmission configuration indicator (TCI) state by a signaling message (1102); determining, by the wireless communication device, TCI state for repetitive transmissions based on the occurrence of beam application time (BAT) (1104).

14. The method of solution 13, wherein the BAT is configured by one or more of the following information: Bandwidth Part (BWP) for all group information sets and BWP for each of group information set.

15. The method of solution 13, the wireless communication device further applies the state when BAT time occurs prior to the first repetitive transmission of a group of transmission.

16. The method of solution 13, wherein the group of transmission comprises one or more of the following patterns: sequential repetition pattern, cyclic repetition pattern, group information set pattern and whole repetition transmission.

17. The method of solution 13, the wireless communication device further determining the applicability of the TCI state.

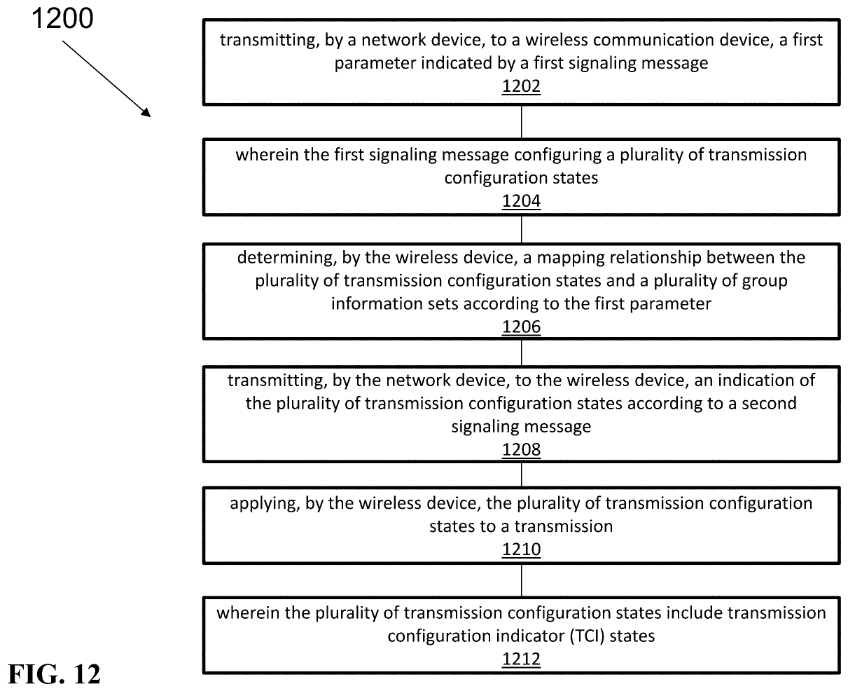

18. A method of wireless communication, as shown in FIG. 12, including transmitting, by a network device, to a wireless communication device, a first parameter indicated by a first signaling message (1202); wherein the first signaling message configuring a plurality of transmission configuration states (1204); determining, by the wireless device, a mapping relationship between the plurality of transmission configuration states and a plurality of group information sets according to the first parameter (1206); transmitting, by the network device, to the wireless device, an indication of the plurality of transmission configuration states according to a second signaling message (1208); and applying, by the wireless device, the plurality of transmission configuration states to a transmission (1210); wherein the plurality of transmission configuration states include transmission configuration indicator (TCI) states (1212).

19. The method of solution 18, wherein the first signaling message comprising a plurality of Medium Access Control-Control Element (MAC-CE) signalings.

20. The method of solution 18, wherein the first parameter further comprising a first index that indicates the mapping relationship between the plurality of transmission configuration states and the plurality of group information sets.

21. The method of solution 18, wherein the second signaling message comprising a downlink control information (DCI) signaling.

22. The method of solution 21, wherein a plurality of codepoints are indicated by the second signaling message.

23. The method of solution 22, wherein one codepoint comprises a first group of transmission configuration states and a second group of transmission configuration states; wherein the first group of transmission configuration and the second group of transmission configuration are activated by the first signaling message.

24. The method of solution 21, wherein the group of transmission configuration states comprise one or more of the following TCI states: a joint TCI state, and a separate TCI state pair.

25. The method of solution 21, wherein the second signaling message further comprising one or more of the following TCI information: TCI state selection information and TCI state transmission order information.

26. The method of solution 22, wherein one codepoint comprises a first group of transmission configuration states or a second group of transmission configuration states; wherein the first group of transmission configuration and the second group of transmission configuration are activated by the first signaling message.

27. The method of solution 21, wherein the second signaling message further comprising one or more of the following information: information for different transmission channels and information for different group information sets.

28. The method of solution 26, wherein the second signaling message further establish an association between the first signaling message and a field in the second signaling message.

29. The method of solution 28, the association between he first signaling message and the field in the second signaling message further indicated by default rules.

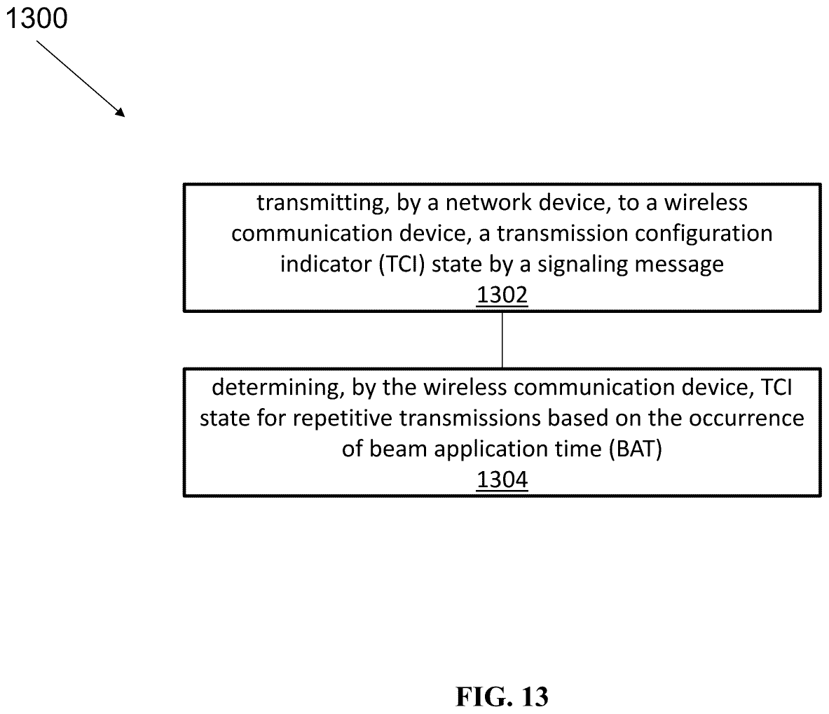

30. A method of wireless communication, as shown in FIG. 13, including transmitting, by a network device, to a wireless communication device, a transmission configuration indicator (TCI) state by a signaling message (1302); determining, by the wireless communication device, TCI state for repetitive transmissions based on the occurrence of beam application time (BAT) (1304).

31. The method of solution 30, wherein the BAT is configured by one or more of the following information: Bandwidth Part (BWP) for all group information sets and BWP for each of group information set.

32. The method of solution 30, the wireless communication device further applies the state when BAT time occurs prior to the first repetitive transmission of a group of transmission.

33. The method of solution 30, wherein the group of transmission comprises one or more of the following patterns: sequential repetition pattern, cyclic repetition pattern, group information set pattern and whole repetition transmission.

34. The method of solution 30, the wireless communication device further determining the applicability of the TCI state.

35. An apparatus for wireless communication comprising a processor configured to implement the method of any of claims 1 to 34.

36. A computer readable medium having code stored thereon, the code when executed by a processor, causing the processor to implement a method recited in any of claims 1 to 34.

It will be appreciated that various techniques have been disclosed to solve potential issues and improve the unified TCI framework for MTRP scenario. This document provides three resolutions and improvements. First, to enhance the association between TCI states and TRPs according to MAC-CE indication. Second, to enhance the DCI indication for MTRP unified TCI states. Third, to enhance the beam application time for MTRP.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a wireless communication device, from a network device, a first parameter indicated by a first signaling message;
wherein the first signaling message configuring a plurality of transmission configuration states;
determining, by the wireless device, a mapping relationship between the plurality of transmission configuration states and a plurality of group information sets according to the first parameter;
receiving, by the wireless device, from a network device, an indication of the plurality of transmission configuration states according to a second signaling message; and
applying, by the wireless device, the plurality of transmission configuration states to a transmission;
wherein the plurality of transmission configuration states include transmission configuration indicator (TCI) states.

2. The method of claim 1, wherein the first parameter further comprising a first index that indicates the mapping relationship between the plurality of transmission configuration states and the plurality of group information sets.

3. The method of claim 1, wherein the second signaling message comprising a downlink control information (DCI) signaling.

4. The method of claim 3, wherein a plurality of codepoints is indicated by the second signaling message.

5. The method of claim 4, wherein one codepoint comprises a first group of transmission configuration states and a second group of transmission configuration states;
wherein the first group of transmission configuration and the second group of transmission configuration are activated by the first signaling message.

6. The method of claim 3, wherein the group of transmission configuration states comprise one or more of the following TCI states: a joint TCI state, and a separate TCI state pair.

7. The method of claim 3, wherein the second signaling message further comprising one or more of the following TCI information: TCI state selection information and TCI state transmission order information.

8. A method of wireless communication, comprising:
transmitting, by a network device, to a wireless communication device, a first parameter indicated by a first signaling message;
wherein the first signaling message configuring a plurality of transmission configuration states;
determining, by the wireless device, a mapping relationship between the plurality of transmission configuration states and a plurality of group information sets according to the first parameter;
transmitting, by the network device, to the wireless device, an indication of the plurality of transmission configuration states according to a second signaling message; and
applying, by the wireless device, the plurality of transmission configuration states to a transmission;
wherein the plurality of transmission configuration states include transmission configuration indicator (TCI) states.

9. The method of claim 8, wherein the first parameter further comprising a first index that indicates the mapping relationship between the plurality of transmission configuration states and the plurality of group information sets.

10. The method of claim 8, wherein the second signaling message comprising downlink control information (DCI) signaling, and wherein a plurality of codepoints is indicated by the second signaling message.

11. The method of claim 10, wherein one codepoint comprises a first group of transmission configuration states or a second group of transmission configuration states;
wherein the first group of transmission configuration and the second group of transmission configuration are activated by the first signaling message.

12. The method of claim 10, wherein the second signaling message further comprising one or more of the following information: information for different transmission channels and information for different group information sets.

13. The method of claim 11, wherein the second signaling message further establish an association between the first signaling message and a field in the second signaling message.

14. The method of claim 13, the association between he first signaling message and the field in the second signaling message further indicated by default rules.

15. An apparatus for wireless communication comprising a processor configured to implement a method comprising:
receiving, by a wireless communication device, from a network device, a first parameter indicated by a first signaling message;
wherein the first signaling message configuring a plurality of transmission configuration states;
determining, by the wireless device, a mapping relationship between the plurality of transmission configuration states and a plurality of group information sets according to the first parameter;
receiving, by the wireless device, from a network device, an indication of the plurality of transmission configuration states according to a second signaling message; and
applying, by the wireless device, the plurality of transmission configuration states to a transmission;
wherein the plurality of transmission configuration states include transmission configuration indicator (TCI) states.

16. The apparatus of claim 15, wherein the first parameter further comprising a first index that indicates the mapping relationship between the plurality of transmission configuration states and the plurality of group information sets.

17. The apparatus of claim 15, wherein the second signaling message comprising a downlink control information (DCI) signaling.

18. The apparatus of claim 17, wherein a plurality of codepoints is indicated by the second signaling message.

19. The apparatus of claim 18, wherein one codepoint comprises a first group of transmission configuration states and a second group of transmission configuration states;
wherein the first group of transmission configuration and the second group of transmission configuration are activated by the first signaling message.

20. The apparatus of claim 17, wherein the group of transmission configuration states comprise one or more of the following TCI states: a joint TCI state, and a separate TCI state pair.
